(19) United States
(12) Patent Application Publication
(10) Pub. No.: US 2006/0033837 A1
(43) Pub. Date: Feb. 16, 2006

(54) Sliding type mobile communication terminal

(75) Inventor: Soo Hwan Kwon, Bucheon (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Pantech Co., Ltd.

(21) Appl. No.: 11/153,015

(22) Filed: Jun. 15, 2005

(30) Foreign Application Priority Data
Aug. 10, 2004 (KR) 10-2004-0062841

(51) Int. Cl. H04N 5/225

(52) U.S. Cl. 348/374

(57) ABSTRACT

A sliding type mobile communication terminal has a main body, a cover slidably connected on the main body, and a PCB mounted to the cover. A bottom surface of the cover is formed with an opening and the PCB is mounted to the opening, thereby forming at least a part of the bottom surface of the cover. According to the mobile communication terminal, since the PCB forms the bottom surface of the cover, it is possible to reduce a thickness of the cover as much as that of the lower housing constituting the bottom surface of the cover compared to a conventional terminal. Accordingly, the terminal can be made to be slim and it is possible to easily carry and handle the terminal.

### CROSS-REFERENCE TO RELATED APPLICATION

This application claims all benefits of Korean Patent Application No. 10-2004-62841, filed on Aug. 10, 2004 in the Korean Intellectual Property Office, the disclosures of which is incorporated herein by reference.

### BACKGROUND OF THE INVENTION

1. Field of the Invention

The present invention relates to a sliding type mobile communication terminal, and more particularly to a sliding type mobile communication terminal making it possible to slim an entirety of the terminal by reducing a thickness of a cover.

2. Description of the Prior Art

A mobile communication terminal such as a sliding type cellular phone and PDA has recently been used which is opened and closed by a cover sliding on a main body.

As shown in FIG. 1, a conventional sliding type mobile communication terminal has a main body 10 and a cover 20 slidably connected on the main body 10.

As shown in FIG. 2, the main body 10 comprises a housing 11. The cover 20 has a lower housing 22 opposing to the housing 11 of the main body 10 and an upper housing 21 connected to an upper part of the lower housing 22 to form a space between the lower housing 22 and the upper housing 21. Two printed circuit boards (PCB) 12 and 23 are respectively mounted to a bottom surface of the housing 11 of the main body 10 and an upper surface of the lower housing 22 of the cover 20.

A rail member 13 for guiding a sliding movement of the cover 20 is provided to an upper surface of the housing 11 of the main body 10. A sliding member 24 slidably connected to the rail member 13 is mounted to a bottom surface of the lower housing 22 of the cover 20. The rail member 13 and the sliding member 24 are fixed to the housings 11 and 22 by bolts 14 and 25, respectively. Both ends of the rail member 13 are provided with bended portions 13a having a “C” shape, respectively. The sliding member 24 has guiding recesses 24a provided to both ends thereof into which the bended portions 13a are inserted. As the guiding recesses 24a move along the bended portions 13a, the cover 20 slidingly moves on the main body 20.

However, according to the terminal of the prior art, since the PCB 23 and the sliding member 24 are connected to the upper and lower surfaces of the lower housing 22 having a thickness, respectively, an overall thickness of the terminal is increased and thus a weight of the terminal is also correspondingly increased. When the thickness and weight of the terminal are increased, it is inconvenient to carry and handle the terminal.

### SUMMARY OF THE INVENTION

Accordingly, the present invention has been made to solve the above-mentioned problems occurring in the prior art. The object of the present invention is to provide a sliding type mobile communication terminal making it possible to slim an entirety of the terminal by reducing a thickness of a cover.

In order to accomplish the object, there is provided a sliding type mobile communication terminal comprising a main body, a cover slidably connected on the main body and a PCB mounted to the cover. The PCB is exposed through a bottom surface of the cover, thereby forming at least a part of the bottom surface of the cover. Accordingly, a thickness of the cover can be reduced as much as a thickness of a housing constituting the bottom surface of the cover, compared to the prior art.

More specifically, the bottom surface of the cover is formed with an opening, and the PCB is mounted to the opening, thereby forming a part of the bottom surface of the cover.

In the mean time, the cover may comprise a lower housing opposing to the main body and an upper housing connected to an upper part of the lower housing to form a space between the lower housing and the upper housing. In this case, the opening is provided to a center of the lower housing, and the PCB is mounted to the opening so that both ends of the PCB are supported by the lower housing.

The mobile communication terminal according to the invention may comprise a rail member mounted to an upper surface of the main body and guiding a sliding movement of the cover and a sliding member mounted to a bottom surface of the PCB and slidably connected to the rail member for a relative movement of the main body and the cover.

According to a preferred embodiment of the invention, the rail member may comprise bended portions provided to both ends thereof in a width direction of the terminal, and the sliding member may comprise guiding recesses provided to both ends thereof in the width direction of the terminal, into which the bended portions of the rail member are inserted.

### BRIEF DESCRIPTION OF THE DRAWINGS

The above and other objects, features and advantages of the present invention will be more apparent from the following detailed description taken in conjunction with the accompanying drawings, in which:

FIG. 1 is a front view of a conventional sliding type mobile communication terminal;

FIG. 2 is a cross sectional view of the conventional sliding type mobile communication terminal; and

FIG. 3 is a cross sectional view of a sliding type mobile communication terminal according to an embodiment of the invention.

### DETAILED DESCRIPTION OF THE PREFERRED EMBODIMENTS

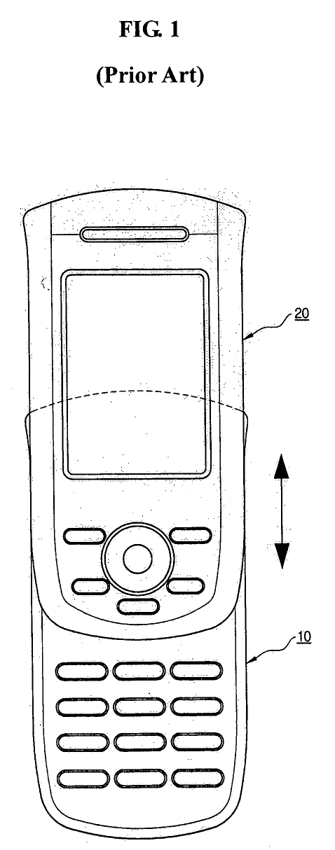

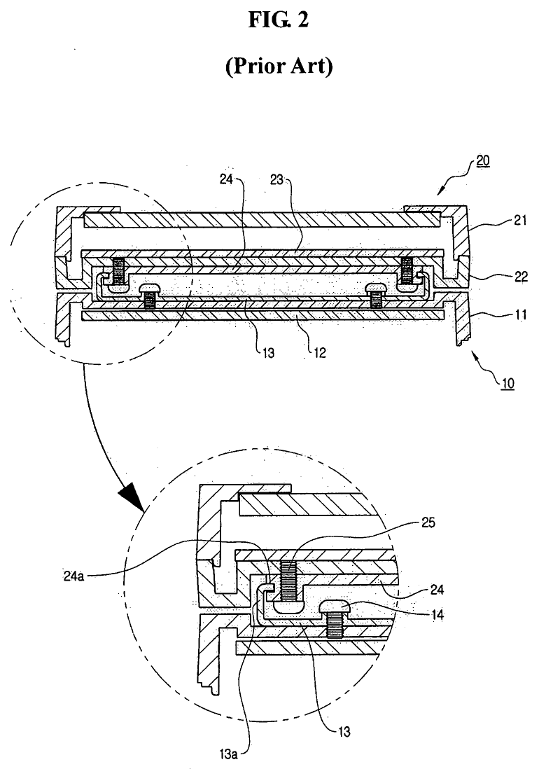

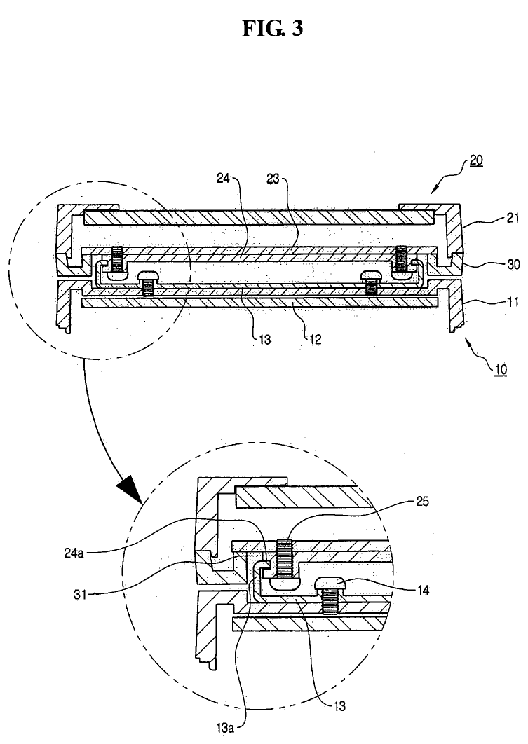

Hereinafter, preferred embodiments of the present invention will be described with reference to the accompanying drawings. In the following description of the present invention, a detailed description of known functions and configurations incorporated herein will be omitted when it may make the subject matter of the present invention rather unclear. In FIG. 3, same reference numerals are used for the same constituting elements as the prior art shown in FIGS. 1 and 2.

FIG. 3 is a cross sectional view of a mobile communication terminal according to an embodiment of the invention. As shown in FIG. 3, the mobile communication terminal has a main body 10 and a cover 20 slidably connected on the main body 10.

The main body 10 has a housing 11. The cover 20 has a lower housing 30 opposing to the housing 11 of the main body 10 and an upper housing 21 connected to an upper part of the lower housing 30 to form a space between the lower housing 30 and the upper housing.

An opening 31 is formed in a center of the lower housing 30. A printed circuit board (PCB) 23 is mounted to the opening 31. In other words, the PCB 23 is exposed through the opening 31 with both sides thereof being supported by the lower housing 30 and thus forms a bottom surface of the main body 10.

Alternatively, the PCB 23 may form a whole bottom surface of the main body 10 without the lower housing 30. In this case, the both sides of the PCB 23 are directly mounted to the upper housing 21.

Another PCB 12 is mounted to a bottom surface of the housing 11 of the main body 10.

A rail member 13 for guiding a sliding movement of the cover 20 is provided to an upper surface of the housing 11 of the main body 10, and a sliding member 24 slidably connected to the rail member 13 is directly mounted to a bottom surface of the PCB 23 of the cover 20.

The rail member 13 is fixed to the housing 11 of the main body 10 by a bolt 14 and the sliding member 24 is fixed to the PCB 23 by a bolt 25. The rail member 13 has bended portions 13a having a “C” shape provided to both ends thereof in a width direction of the terminal. The sliding member 24 has guiding recesses 24a provided to both ends thereof in the width direction of the terminal into which the bended portions 13a of the rail member 13 are inserted. As the guiding recesses 24a move along the bended portions 13a, the cover 20 slidingly moves on the main body 10.

According to the mobile communication terminal of the invention, since the rail member 13 is directly mounted to the bottom surface of the PCB 23 under state that the PCB 23 forms the bottom surface of the main body 10, a thickness of the cover 20 can be reduced as much as a thickness of the lower housing, compared to the prior art.

As described above, according to the invention, since the PCB forms the bottom surface of the cover and the sliding member is directly connected to the PCB, it is possible to reduce the thickness of the cover as much as that of the lower housing constituting the bottom surface of the cover compared to the prior art. Accordingly, the terminal can be made to be slim and it is possible to easily carry and handle the terminal.

Although a few preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. A sliding type mobile communication terminal comprising:
a main body;
a cover slidably connected on the main body; and
a PCB mounted to the cover, wherein the PCB is exposed through a bottom surface of the cover, thereby forming at least a part of the bottom surface of the cover.

2. The terminal according to claim 1, wherein an opening is formed in the bottom surface of the cover and the PCB is mounted to the opening.

3. The terminal according to claim 2, wherein the cover comprises a lower housing opposing to the main body, and an upper housing connected to an upper part of the lower housing to form a space between the lower housing and the upper housing,
the opening is formed in a center of the lower housing, and both ends of the PCB are supported by the lower housing.

4. The terminal according to claim 2, further comprising a rail member mounted to an upper surface of the main body and guiding a sliding movement of the cover, and a sliding member directly mounted to a bottom surface of the PCB and slidably connected to the rail member.

5. The terminal according to claim 4, wherein the rail member comprises bended portions having an approximately “C” shape provided to both ends thereof in a width direction of the terminal, and the sliding member comprises guiding recesses provided to both ends thereof in the width direction of the terminal into which the bended portions of the rail member are inserted.
